(19) United States
(12) Patent Application Publication
(10) Pub. No.: US 2018/0268289 A1
(43) Pub. Date: Sep. 20, 2018

(54) Method and System for Training a Digital Computational Learning System

(71) Applicant: Nuance Communications, Inc., Burlington, MA (US)

(72) Inventor: Alfred K. Wong, Burlington, MA (US)

(21) Appl. No.: 15/459,720

(22) Filed: Mar. 15, 2017

(51) Int. Cl. G06N 3/08; G06N 3/04

(52) U.S. Cl. CPC G06N 3/08; G06N 3/04

(57) ABSTRACT

Techniques for a fixed-point back propagation implementation with advantages in speed, memory usage, and precision as compared with a floating-point implementation have hitherto been elusive. An example embodiment of a 16-bit fixed-point back propagation method that achieves a same accuracy as a double-precision, floating-point implementation, as measured by a word-error-rate (WER) of an acoustic adaptation application using one hour of audio data is disclosed. The WER for a speaker-independent model is 5.85%, compared with 5.34% for a double-precision floating-point implementation, and 5.33% for a 16-bit fixed-point implementation according to an example embodiment. Further, an average number of compute cycles for one backward propagation stage decreases from 166784 for a floating-point implementation to 30232 for a fixed-point implementation according to an example embodiment.

### BACKGROUND

A goal of a neural network is to solve problems in a same way that a human brain would solve them. Back propagation, also referred to interchangeably herein as backpropagation or backward propagation, may be used for training a neural network. There are two distinct phases to a back propagation method, a forward phase and a backward phase, also referred to referred to interchangeably herein as a forward pass and backward pass, respectively. In the forward phase, input signals may propagate through the neural network layer by layer and eventually produce an actual response at an output of the neural network. The actual response may be compared with a target, that is, an expected response. In the backward phase, error signals may be generated based on the difference between the actual response and the expected response and propagated in a backward direction through the neural network. Adjustments may be made in the neural network, for example, adjustments may be made to connection weights between neurons in the neural network, in order to make the actual response move closer to the expected response.

### SUMMARY

According to an example embodiment, a method for training a digital computational learning system may comprise computing a sum of a present error term and an accumulated error term. The present error term may be a function of an expected output and an actual output of the digital computational learning system to a given input in a present iteration of the training. The accumulated error term may be accumulated over previous iterations of the training. The present error term, accumulated error term, and the sum may have a finer granularity relative to a coarser granularity of adjustable parameters within the digital computational learning system. The method may comprise converting the sum to a converted sum having the coarser granularity. The method may comprise adjusting the adjustable parameters as a function of the converted sum in the present iteration. The method may comprise updating the accumulated error term, having the finer granularity, for use in adjusting the adjustable parameters, having the coarser granularity, in a next iteration of the training of the digital computational learning system. The updating may include applying a difference between the converted sum and the sum, the difference having the finer granularity. The computing, converting, adjusting, and updating may improve a computational speed and reduce a memory usage of the digital computational learning system while maintaining an accuracy of the training relative to a different method of training the digital computational learning system, the different method based exclusively on one or more finer granularities that are finer than the coarser granularity.

The digital computational learning system may be a neural network. The neural network may be a feed-forward neural network, convolutional neural network, recurrent neural network, or long short-term memory neural network. The neural network may include a back propagation stage; the back propagation stage may include the computing, converting, adjusting, and updating. The adjustable parameters may be connection weights between neurons and biases of neurons of the neural network. The adjusting may include applying multiplying factors of value greater than one. The multiplying factors may include a weight multiplying factor or a bias multiplying factor. The applying may include applying the weight multiplying factor to a connection weight parameter and the bias multiplying factor to a bias parameter.

The method may further comprise computing the multiplying factors and a first and second back propagation scaling factor based on a first, second, and third forward propagation scaling factor. Computing the multiplying factors and the first and second back propagation scaling factors may include setting a maximum scaling factor value based on a numerical overflow constraint. Computing the first back propagation scaling factor may be based on a first ratio of the maximum scaling factor value to the second forward propagation scaling factor. Computing the second back propagation scaling factor may be based on a first product of the second forward propagation scaling factor and the first back propagation scaling factor computed. Computing the weight multiplying factor may be based on a second ratio of a second product of the third forward propagation scaling factor and the first back propagation scaling factor computed to the second forward propagation factor. Computing the bias multiplying factor may be based on a third ratio of the second back propagation scaling factor computed to the first forward propagation scaling factor. The first, second, and third forward propagation scaling factors and the first and second back propagation scaling factors may enable conversion of values of the one or more finer granularities to the coarser granularity.

The method may further comprise setting the bias multiplying factor based on at least two constraints. The at least two constraints may include (a) constraining the bias multiplying factor to a value greater than one and (b) constraining a first ratio to an integer. The first ratio may be computed based on the bias multiplying factor and a first, second, and third forward propagation scaling factor. The first ratio may relate a first product to the second forward propagation scaling factor squared. The first product may be produced by multiplying the bias multiplying factor with the first and third forward propagation scaling factors. The method may comprise computing the weight multiplying factor by computing the first ratio. The method may comprise computing a first and second back propagation scaling factor, wherein the second back propagation scaling factor may be computed based on a second product of the bias multiplying factor and the first forward propagation factor. The first back propagation scaling factor may be based on a second ratio of the second back propagation scaling factor computed to the second forward propagation scaling factor. The first, second, and third forward propagation scaling factors and the first and second back propagation scaling factors may enable conversion of values of the one or more finer granularities to the coarser granularity.

At least one processor may compose the digital computational learning system.

The given input may be a digital representation of a voice, image, or signal and the method may further include employing the digital computational learning system in a speech recognition, image recognition, motion control, or communication application.

The method may further include employing the digital computational learning system in a credit card, fraud detection, tax return, income level, foreign account, bank account, tax level, or health care application, or other application that distinguishes between sets of things.

According to another example embodiment, a system for training a digital computational learning system may comprise at least one processor and at least one memory storing a sequence of instructions which, when loaded and executed by the at least one processor, configures the at least one processor to be the digital computational learning system and causes the at least one processor to compute a sum of a present error term and an accumulated error term. The present error term may be a function of an expected output and an actual output of the digital computational learning system to a given input in a present iteration of the training. The accumulated error term may be accumulated over previous iterations of the training. The present error term, accumulated error term, and the sum may have a finer granularity relative to a coarser granularity of adjustable parameters within the digital computational learning system. The sequence of instructions may cause the at least one processor to convert the sum to a converted sum having the coarser granularity. The sequence of instructions may cause the at least one processor to adjust the adjustable parameters as a function of the converted sum in the present iteration. The sequence of instructions may cause the at least one processor to update the accumulated error term, having the finer granularity, for use in adjusting the adjustable parameters, having the coarser granularity, in a next iteration of the training of the digital computational learning system. The updating may including applying a difference between the converted sum and the sum, the difference having the finer granularity. The compute, convert, adjust, and update operations may improve a computational speed and reduce a memory usage of the digital computational learning system while maintaining an accuracy of the training relative to a different method of training the digital computational learning system, the different method based exclusively on one or more finer granularities finer than the coarser granularity.

The digital computational learning system may be a neural network. The neural network may be a feed-forward neural network, convolutional neural network, recurrent neural network, or long short-term memory neural network. The neural network may include a back propagation stage, the back propagation stage may include the compute, convert, adjust, and update operations. The adjustable parameters may be connection weights between neurons and biases of neurons of the neural network and wherein to adjust the adjustable parameters, the sequence of instructions may further cause the at least one processor to apply multiplying factors of value greater than one. The multiplying factors may include a weight multiplying factor or a bias multiplying factor and wherein to adjust the adjustable parameters, the sequence of instructions may further cause the at least one processor to apply the weight multiplying factor to a connection weight parameter or the bias multiplying factor to a bias parameter.

To train the digital computational learning system, the sequence of instructions may further cause the at least one processor to compute the multiplying factors and a first and second back propagation scaling factor based on a first, second, and third forward propagation scaling factor. To compute the multiplying factors and the first and second back propagation scaling factors, the sequence of instructions may further cause the at least one processor to set a maximum scaling factor value based on a numerical overflow constraint. The sequence of instructions may further cause the at least one processor to compute the first back propagation scaling factor based on a first ratio of the maximum scaling factor value to the second forward propagation scaling factor. The sequence of instructions may further cause the at least one processor to compute the second back propagation scaling factor based on a first product of the second forward propagation scaling factor and the first back propagation scaling factor computed. The sequence of instructions may further cause the at least one processor to compute the weight multiplying factor based on a second ratio of a second product of the third forward propagation scaling factor and the first back propagation scaling factor computed to the second forward propagation factor. The sequence of instructions may further cause the at least one processor to compute the bias multiplying factor based on a third ratio of the second back propagation scaling factor computed to the first forward propagation scaling factor. The first, second, and third forward propagation scaling factors and the first and second back propagation scaling factors may enable conversion of values of the finer granularity to the coarser granularity.

To train the digital computational learning system, the sequence of instructions may further cause the at least one processor to set the bias multiplying factor based on at least two constraints. The at least two constraints may include (a) constraining the bias multiplying factor to a value greater than one and (b) constraining a first ratio to an integer. The first ratio may be computed based on the bias multiplying factor and a first, second, and third forward propagation scaling factor. The first ratio may relate a first product to the second forward propagation scaling factor squared. The first product may be produced by multiplying the bias multiplying factor with the first and third forward propagation scaling factors. The sequence of instructions may further cause the at least one processor to compute the weight multiplying factor by computing the first ratio. The sequence of instructions may further cause the at least one processor to compute a first and second back propagation scaling factor, wherein the second back propagation scaling factor may be computed based on a second product of the bias multiplying factor and the first forward propagation factor. The first back propagation scaling factor may be based on a second ratio of the second back propagation scaling factor computed to the second forward propagation scaling factor. The first, second, and third forward propagation scaling factors and the first and second back propagation scaling factors may enable conversion of values of the one or more finer granularities to the coarser granularity.

The given input may be a digital representation of a voice, image, or signal and the sequence of instructions may further cause the at least one processor to employ the digital computational learning system in a speech recognition, image recognition, motion control, or communication application.

The digital computational learning system may be employed in a credit card, fraud detection, tax return, income level, foreign account, bank account, tax level, or health care application, or other application that distinguishes between sets of things.

According to another example embodiment, a non-transitory computer-readable medium for training a neural network may have encoded thereon a sequence of instructions which, when loaded and executed by at least one processor, causes the at least one processor to compute a sum of a present error term and an accumulated error term. The present error term may be a function of an expected voice related output and an actual voice related output of the neural network to a given voice related input in a present iteration of the training. The accumulated error term may be accumulated over previous iterations of the training. The present error term, accumulated error term, and the sum may have a finer granularity relative to a coarser granularity of adjustable parameters within the neural network. The sequence of instructions may cause the at least one processor to convert the sum to a converted sum having the coarser granularity. The sequence of instructions may cause the at least one processor to adjust the adjustable parameters as a function of the converted sum in the present iteration. The sequence of instructions may cause the at least one processor to update the accumulated error term, having the finer granularity, for use in adjusting the adjustable parameters, having the coarser granularity, in a next iteration of the training of the digital computational learning system. The update operation may include applying a difference between the converted sum and the sum, the difference having the finer granularity. The neural network may include a back propagation stage, the back propagation stage may including the compute, convert, adjust, and update operations. The compute, convert, adjust, and update operations may improve a computational speed and reduce a memory usage of the neural network while maintaining an accuracy of the training relative to a different method of training the neural network, the different method based exclusively on one or more finer granularities finer than the coarser granularity.

Yet another example embodiment may include a non-transitory computer-readable medium having stored thereon a sequence of instructions which, when loaded and executed by a processor, causes the processor to complete methods disclosed herein.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example embodiment of a speech recognition system.

FIG. 2 is a flow diagram of an example embodiment of a method for training a digital computational learning system.

FIG. 3 is a block diagram of an example embodiment of a neural network.

FIG. 4 is a block diagram of an example embodiment of a directed acyclic graph (DAG) for the example embodiment of the neural network of FIG. 3.

FIG. 5 is a listing of an example embodiment of a pseudo-method of high-level neural network training.

FIG. 6 is a block diagram of an example internal structure of a computer optionally within an embodiment disclosed herein.

### DETAILED DESCRIPTION

A description of example embodiments follows.

Training a neural network may be a computationally intensive process. Neural networks may be employed by a variety of applications, such as a speech recognition application, or any other suitable application. Embodiments disclosed herein enable a neural network to employ a fixed-point back propagation implementation, which has hitherto been elusive, with advantages in speed, memory usage, and precision, as compared with a floating-point implementation. Embodiments disclosed herein may be employed by a digital learning system, such as a neural network, or any other suitable digital learning system, such as disclosed herein. Further, embodiments disclosed herein are not restricted to fixed-point or floating-point representations and may be applied to any suitable representations of a number that enable actual values of the number to be represented with a coarser granularity relative to a finer granularity representation of the present error term, accumulated error term, and the sum of the embodiment or one or more finer granularities of a different method, wherein the one or more finer granularities may include the finer granularity. Still further, embodiments disclosed herein are not restricted to back propagation, as disclosed, further below.

In an embodiment in which granularities are fixed-point and floating-point, techniques disclosed herein enable a fixed-point back propagation implementation with advantages in speed, memory usage, and precision as compared with a floating-point implementation. An example embodiment of a 16-bit fixed-point back propagation method that achieves a same accuracy as a double-precision, floating-point implementation, as measured by a word-error-rate (WER) of an acoustic adaptation application using one hour of audio data is disclosed further below. As disclosed further below, the WER for a speaker-independent model is 5.85%, compared with 5.34% for a double-precision floating-point implementation, and 5.33% for a 16-bit fixed-point adaptation according to an example embodiment. Further, an average number of compute cycles for one backward propagation stage decreases from 166784 for a floating-point implementation to 30232 for a fixed-point implementation according to an example embodiment, as disclosed further below.

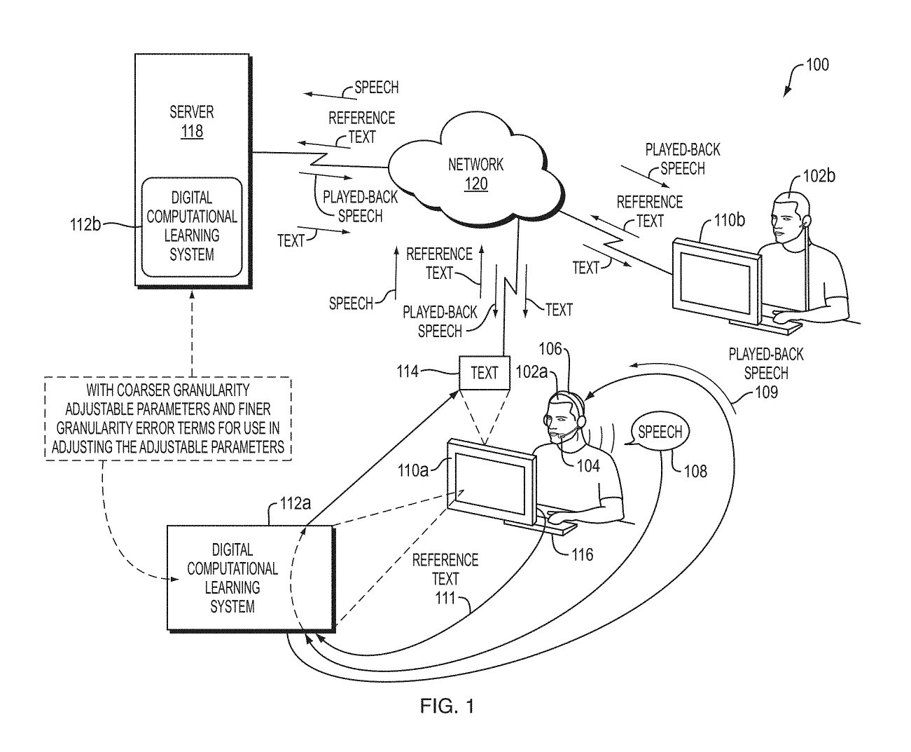

FIG. 1 is a network diagram of an example embodiment of a speech recognition system 100. In the speech recognition system 100, a user 102a is speaking into a microphone 104 of a headset 106. A speech waveform 108 of the user 102a may be received at an audio interface (not shown) of a computing device 110a. The computing device 110a may be any suitable computing device that employs at least one processor. The computing device 110a may be a mobile or stationary electronic device. The computing device 110a may receive an electronic representation (not shown) of the speech waveform 108 via the microphone 104 and employ a digital learning system 112a to convert the speech waveform 108 to text 114 that may be presented to the user 102a via a user interface (not shown) of the computing device 110a.

The digital learning system 112a may send played-back speech 109 that may be a recorded version of the speech waveform 108 that may be played back for the user 102a via the headset 106. The user 102a may input reference text 111 that may include one or more corrections to the text 114. The reference text 111 may be input to the computing system 110a as audio or text via the microphone 104 or a keyboard 116, respectively. It should be understood that the microphone 104 and keyboard 116 may be any suitable electronic devices that enable the user 102a to input audio or data, respectively, to the computing device 110a. The digital learning system 112a may be updated based on the reference text 111 from the user 102a such that the digital learning system 112a improves accuracy for converting the speech waveform 108 of the user 102a to the text 114.

Alternatively, the electronic representation of the speech waveform 108 may be sent from a network interface (not shown) of the computing device 110a via a network 120 and communicated to a server 118. The network 120 may be a wireless network or any other suitable network that enables the electronic representation of the speech waveform 108 to be communicated to the server 118. It should be understood that the electronic representation of the speech waveform 108 may be communicated as a data file or any other suitable electronic representation of the speech waveform 108. The server 118 may employ a digital learning system 112b to convert the speech waveform 108 to the text 114 and communicate both or one of the text 114 and played-back speech 109 to the computing device 110a such that the text 114 may be presented to the user 102a. The user 102a may listen to the played-back speech 109 and enter the reference text 111 that may be communicated back to the server 118 for updating the digital learning system 112b.

Alternatively, the played-back speech 109 and the text 114 may be communicated via the network 120 by either the server 118 or the computing device 110a to another computing device 110b that may present the text 114 to another user 102b who may listen to the played-back speech 109 and enter the reference text 111 that may be communicated via the network 120 to the computing device 110a or the server 118 for updating the digital learning system 112a or 112b, respectively.

The speech waveform 108 may be received in real-time as the user 102a generates speech utterances. Alternatively, the speech waveform 108 may be a recording of the speech utterances received from the user 102a. Regardless of whether the speech waveform 108 represents speech utterances generated in real-time or recorded speech utterances, the speech waveform 108 may represent an input to the digital computational learning system 112a or 112b that is used to determine an actual output. A collection of such actual outputs may combine to give a converted text, such as the text 114. The actual output (as well as the expected output) may be a phoneme. The converted text 114 and the reference text 111 may be pieced together based on a collection of such phonemes. Further, the reference text 111 may be used to derive an expected output from the digital computational learning system 112a or 112b in response to an input, that is, the speech waveform 108. The expected output may be used to improve accuracy of the actual output of the digital computational learning system 112a or 112b.

The expected output may be a known expected output that may be obtained by the digital computational learning system 112a or 112b in any suitable manner. For example, the reference text 111 from which the expected output may be derived may be received from the user, such as the reference text 111 that is received from the user 102a. Alternatively, the expected output may be derived based on a transcription of recorded speech utterances of the speech waveform 108 or by using a speech recognition model (that may be the digital computational learning system 112a or 112b) to the speech waveform 108 in order to obtain a reference text 111 from which the expected output can be derived.

It should be understood that embodiments disclosed herein are not restricted to a neural network or to back propagation. According to an example embodiment, the digital learning system 112a or 112b may employ a training method that may comprise iterations of a production phase, error determination phase, and an update phase. The production phase may include using values of low-precision adjustable model parameters at a current iteration and computing how well those adjustable model parameters model training data, such as the electronic representation of the speech waveform 108 from the user 102a. The error determination phase may compute how much each parameter is to be adjusted based on computation in the production phase. An amount of the adjustment may be computed as a higher-precision value and how the high-precision value is computed may be different for each type of model such as a neural network, Gaussian mixture model (GMM), or clustering model. In the update phase, each adjustable parameter may be adjusted based on a result computed from the error determination phase and a parameter-specific accumulated residual error and each parameter-specific accumulated residual error may be updated.

For a neural network model, the production phase may be forward propagation and the error determination phase may be backward propagation, as disclosed further below. For a GMM model, the GMM may be trained using the so-called expectation maximization (EM) approach, in which an expectation step (i.e., E-step) may be the production phase and a maximization step (i.e., M-step) may be the error determination and update phases.

A clustering model may employ a k-means clustering approach that may determine clusters given a collection of points. The cluster centers may be adjustable parameters. In the production phase, the collection of points may be divided into clusters depending on a location of cluster centers at the current iteration. In the error determination and update phases, the cluster centers may be re-computed based on a result of the division in the production phase.

Example embodiments disclosed herein enable a practical fixed-point back propagation implementation with advantages in speed, memory usage, and precision as compared with a floating-point implementation. Such a practical fixed-point back propagation implementation has hitherto been elusive. According to an example embodiment of a 16-bit fixed-point back propagation method, an increase in computation speed, reduced memory usage, and precise numerical results across compute platforms may be achieved, all at the same accuracy, as measured by word-error-rate (WER), as compared with a corresponding double-precision floating-point implementation, as disclosed, further below. Such example embodiments may improve functioning of any computer device implementing training of a digital learning system, such as the digital learning system 112a or 112b of FIG. 1, disclosed above, that may comprise iterations of the production, error determination, and update phases, as disclosed above.

According to an example embodiment, a digital learning system, such as the digital learning system 112a or 112b of FIG. 1, disclosed above, may be a neural network. An electronic representation of the speech waveform 108 may be input to the neural network, such as frequencies, cepstral coefficients, or acoustic features (not shown) of the speech waveform 108 that may propagate through the neural network layer-by-layer and eventually produce an actual response at an output of the neural network. The actual response may be compared with a target, that is, a desired (i.e., expected) response, that may be a phoneme associated with a snapshot of the speech corresponding to the text 114 as corrected by the reference text 111 disclosed above in FIG. 1. Error signals may be generated and propagated in a backward direction through the neural network for making adjustments in order to make the overall actual response move closer to the overall desired response (i.e., overall expected response), that is, to make the text 114 reflect the reference text 111 given the same input speech waveform 108.

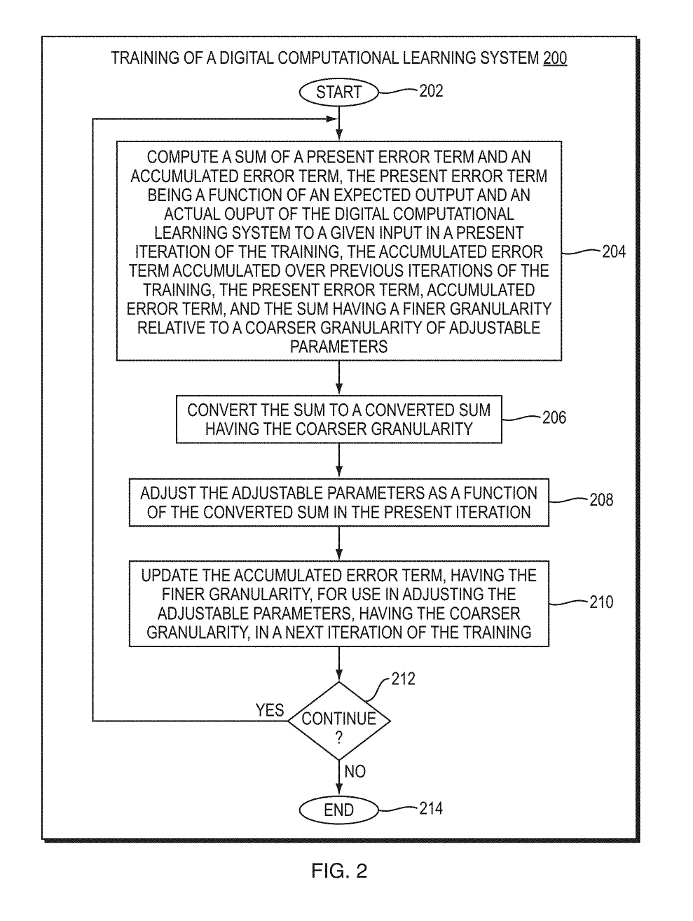

FIG. 2 is a flow diagram 200 of an example embodiment of a method for training a digital computational learning system. The method may begin (202) and compute a sum of a present error term and an accumulated error term (204). The present error term may be a function of an expected output and an actual output of the digital computational learning system (such as 112a or 112b) to a given input in a present iteration of the training. For example, the present error term may be a function of a delta between the expected output and the actual output. The accumulated error term may be accumulated over previous iterations of the training. The present error term, accumulated error term, and the sum may have a finer granularity relative to a coarser granularity of adjustable parameters within the digital computational learning system. The method may convert the sum to a converted sum having the coarser granularity (206). The method may adjust the adjustable parameters as a function of the converted sum in the present iteration (208). The method may update the accumulated error term, having the finer granularity, for use in adjusting the adjustable parameters, having the coarser granularity, in a next iteration of the training of the digital computational learning system (210). The update operation may include applying a difference between the converted sum and the sum, the difference having the finer granularity. The compute, convert, adjust, and update operations may improve a computational speed and reduce a memory usage of the digital computational learning system while maintaining an accuracy of the training relative to a different method of training the digital computational learning system, the different method based exclusively on one or more finer granularities finer than the coarser granularity. The method thereafter checks for whether to continue (212). If yes, the method returns to compute (204) again, whereas if no, the method thereafter ends (214), in the example embodiment.

As such, an example embodiment may include at least three granularities: (i) a coarser granularity for the adjustable parameters, (ii) a finer granularity for the present error term, the accumulated error term, and the sum, and (iii) one or more finer granularities employed by the different method. Scaling factors, disclosed further below, may relate the coarser granularity (i) and the one or more finer granularities (iii). In an example embodiment, the coarser granularity (i) may be in 16-bit integers, the finer granularity (ii) may be in 32-bit integers, and the one or more finer granularities (iii) may be in double-precision floating-point numbers. According to an example embodiment, the finer granularity (ii) may be the same as a given finer granularity of the one or more finer granularities (iii) employed by the different method, for example, both the finer granularity and the given finer granularity may be in single-precision or double-precision floating-point. Alternatively, the finer granularity (ii) may be finer or coarser than the one or more finer granularities (iii) employed by the different method. However, it should be understood that the coarser granularity (i) is coarser than both the finer granularity (ii) and the one or more finer granularities (iii) that are employed by the different method.

At least one processor may compose the digital computational learning system. The at least one processor may be at least one graphics processing unit (GPU), central processing unit (CPU), a combination thereof, or any other suitable at least one processor. The at least one processor may be a single processor. Alternatively, the digital computational learning system may be distributed amongst multiple processors such that multiple processors compose the digital computational learning system.

The given input may be a digital representation of a voice, such as a digital representation of a voice of the user 102a, disclosed above with reference to FIG. 1, image, or signal and the method may further include employing the digital computational learning system in a speech recognition application, such as the speech recognition application disclosed above with reference to FIG. 1, image recognition application, motion control application, or communication application.

The method may further include employing the digital computational learning system in a credit card, fraud detection, tax return, income level, foreign account, bank account, tax level, or health care application, or other application that distinguishes between sets of things. For example, in a speech recognition application, the sets of things may be sets of phonemes constituting a speech. In a credit card application, the sets of things may be sets of transactions that may be authentic or fraudulent, etc. In a health care application. The sets of things may be possible causes of symptoms from patient records. The sets of things may be sets of elements with a common type applicable to an application type of the corresponding application. Distinguishing between sets of things may enable the application to generate an application specific output, such as an audit flag in a tax return for a tax-level application, fraud detection alert in fraud detection application, prescription check notification in a health care application that may determine whether a particular prescription matches a patient's symptoms in the patient's records, etc.

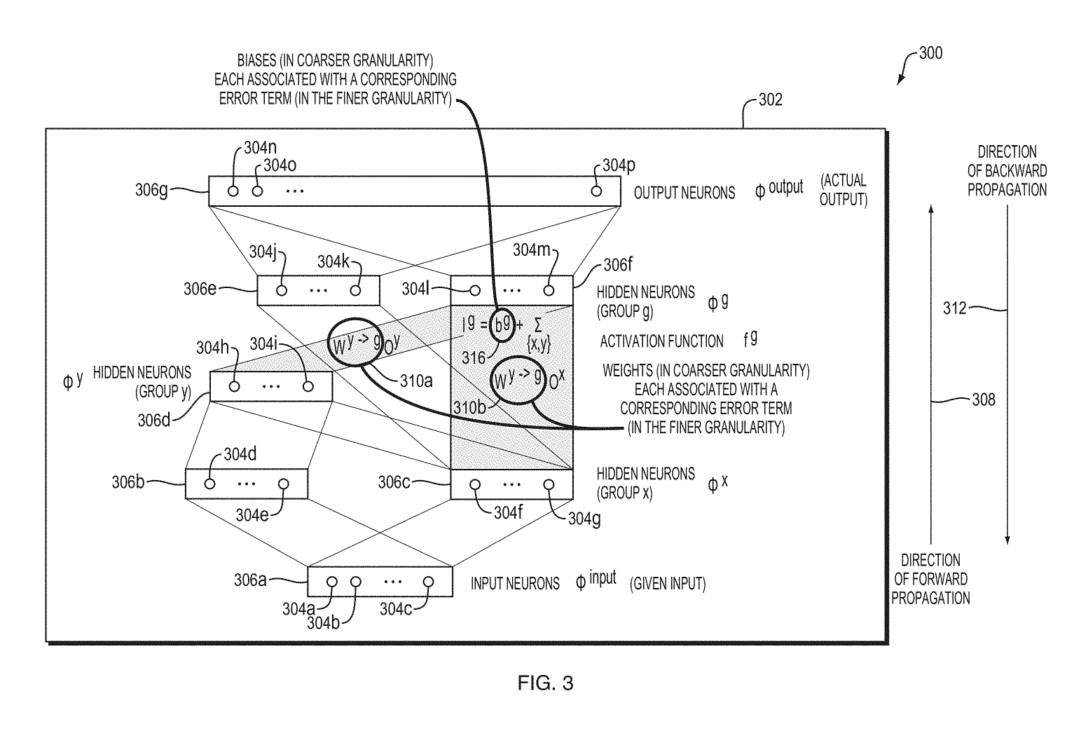

The digital computational learning system may be a neural network. The neural network may be a feed-forward neural network, convolutional neural network, recurrent neural network, or long short-term memory neural network. The adjustable parameters may be connection weights between neurons and biases of neurons of the neural network, such as the connection weights 310 of the neural network 302 of FIG. 3, disclosed further below. The adjusting may include applying multiplying factors of value greater than one. The multiplying factors may include a weight multiplying factor or a bias multiplying factor, such as m_{w}^{precision} and m_{b}^{precision}, disclosed further below. The applying may include applying the weight multiplying factor to a connection weight parameter, such as w_{j,k}^{g′→g}, disclosed further below, and the bias multiplying factor to a bias parameter, such as bⱼ^{g}, disclosed further below. The neural network may include a back propagation stage; the back propagation stage may include the computing, converting, adjusting, and updating. An overview of neural networks is disclosed below.

Neural Network Basics

Topology

FIG. 3 is a block diagram 300 of an example embodiment of a neural network 302. Neurons in the neural network 302, such as the neurons 304a-p depicted by circles in FIG. 3, are most conveniently conceptualized as divided into groups. The groups may group neurons that function in a similar manner. Each group Φ, such as the groups 306a-g, is bounded by a rectangle. FIG. 3 includes one input neuron group 306a denoted by Φ^{imput}, although, in general, there can be multiple input groups in the neural network 302. The neural network 302 also includes one group of output neurons 306g, denoted by Φ^{output}, and five groups of hidden neurons, that is, the groups 306b-f. A general neural network can have an arbitrary number n_{G} of hidden neuron groups, namely, n_{G} ∈ {0, 1, 2, . . . }. Each of these n_{G} groups of neurons may be denoted by Φ⁰, Φ¹, Φ², . . . , Φⁿ_{G}⁻¹. The (j+1)^{th} neuron in a group Φ^{g} with n^{g} number of neurons may be denoted by Øⱼ^{g}, with j ∈ {0, 1, 2, . . . , n^{g-1}}. Similarly, Øⱼ^{input} and Øₖ^{output} respectively denote the (j+1)^{th} input neuron and the (k−1)^{th} output neuron, with 0≤j<n^{input} and 0≤k<nₒᵤₜₚᵤₜ.

The adjustable parameters may include connection weights, such as the connection weights 310a and 310b between neurons in the neural network 302. The adjustable parameters may include biases 316 of neurons of the neural network 302. The adjustable parameters, such as the connection weights 310a or 310b or biases 316 may each be associated with a corresponding present error term (not shown) that is of the finer granularity in the example embodiment. The connection weights 310a and 310b may be in the coarser granularity, whereas the corresponding present error terms (not shown), such as the present error terms (not shown) associated with the connection weights 310a or biases 316, may be of the finer granularity in the example embodiment. Similar to the connection weights 310a and 310b, the biases 316 may be in the coarser granularity in the example embodiment. In contrast to the example embodiment, connections weights and biases of a neural network according to the different method are in the one or more finer granularities that are finer with respect to the coarser granularity and may include the finer granularity.

In the example embodiment of FIG. 3, an iteration comprises (a) forward propagation in the direction of forward propagation 308 from the input neuron group 306a to the output neuron group 306g, (b) backward propagation in the direction of backward propagation 312 from the output neuron group 306g to any of the hidden neuron groups 306b-f or the input neuron group 306a, and (3) computing the adjustment to parameters, such the connection weights 310a and 310b or the biases 316. It should be understood that back propagation may stop short of the input neuron group depending on the adjustable parameters that are desired to be adjusted.

In applications such as classification using a feed-forward neural network, signals in the network propagate in a forward direction, such as the forward direction of forward propagation 308 of FIG. 3, in which signals propagate from the input group Φ^{input} 306a through the hidden groups to the output group Φ^{output} 306g, in a direction opposite to signals propagating in a backward direction, such as the direction of backward propagation 312. For such applications, it is helpful to view the neural network as a directed acyclic graph (DAG), where nodes in the DAG correspond to neuron groups and edges correspond to connections between groups. Although not necessarily so, recurrent neural networks can also be represented as DAGs. Whether a general neural network is so represented is immaterial for purposes of this disclosure. The techniques disclosed herein are applicable to both feed-forward and recurrent neural networks, as well as other digital learning systems disclosed herein.

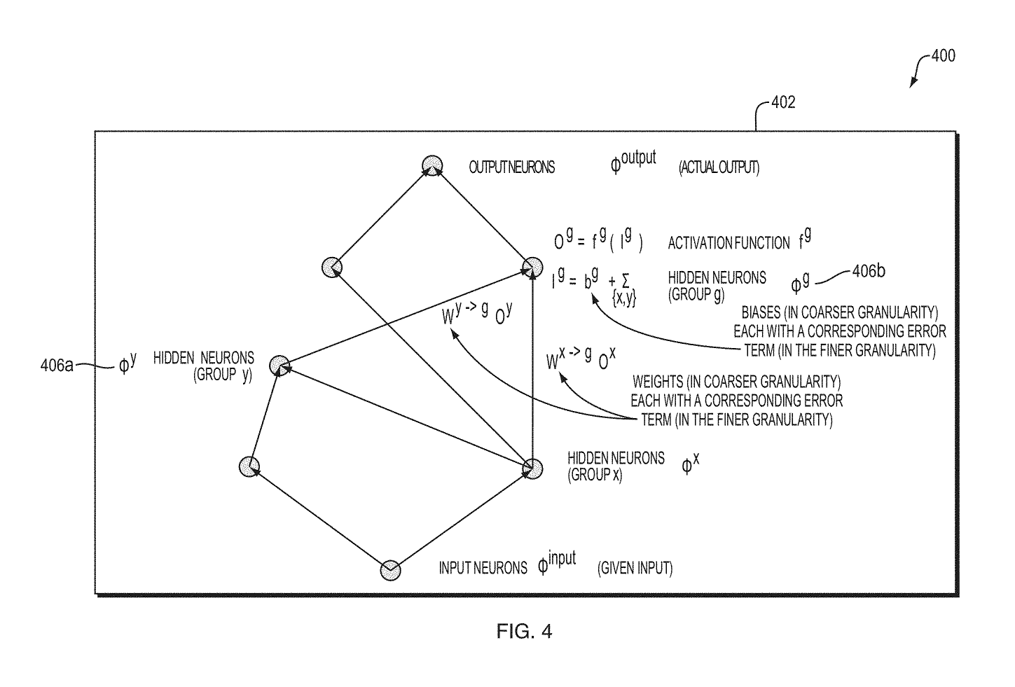

FIG. 4 is a block diagram 400 of an example embodiment of a DAG 402 for the example embodiment of the neural network 302 of FIG. 3. During forward propagation, each upstream group in the DAG 402 sends signals to its connected downstream groups. For example, Φ^{y} 406a in FIG. 4 is upstream with respect to Φ^{g} 406b and Φ^{g} 406b is downstream with respect to Φ^{y} 406a. Conversely, each downstream group obtains its input signals from its connected upstream groups. The downstream group then modifies the signals, using an activation function, as disclosed in the Neuron Activation section below, and passes the modified signals onto its connected downstream groups via forward propagation, as disclosed further below.

Neuron Activation

Each neuron in a neural network can b e viewed as an input-output transformation. The mathematics governing the relationship between its input and output values is captured by the activation function. If the input value of the (j+1)^{th} neuron in group Φ^{g} is denoted by iⱼ^{g} and the output value is denoted by oⱼ^{g}, then:

oⱼ^{g}=f^{g}(iⱼ^{g}),

where f^{g} is the activation function for Φ^{g} (under the assumption, without loss of generality, that neurons in a same group have a same activation function). The activation function can take many forms, some common ones are:

$${f}^{g} ( {i}_{j}^{g} ) = \frac{1}{1 + exp ( {i}_{j}^{g} )} = {f}_{sigmoid} \qquad sigmoid ,$$

$${f}^{g} ( {i}_{j}^{g} ) = \frac{exp ( {i}_{j}^{g} )}{{\sum }_{k = 0}^{{n}^{g} - 1} exp ( {i}_{k}^{g} )} = {f}_{softmax} \qquad softmax ,$$

$${f}^{g} ( {i}_{j}^{g} ) = max ( 0 , {i}_{j}^{g} ) = {f}_{ReLU} \qquad rectified linear unit ( ReLU ) , and$$

$${f}^{g} ( {i}_{j}^{g} ) = {i}_{j}^{g} = {f}_{identity} \qquad identity .$$

Forward Propagation

The previous section explained how oⱼ^{g} is obtained from iⱼ^{g}. But how is the value iⱼ^{g} determined? Referring to FIGS. 3 and 4, disclosed above, each neuron group (except for Φ^{input}, which receives signals external to the neural network 302) receives its input signals from the output values of its connected upstream groups. Denoting by S_{incoming}^{g} the set of neuron groups that send signals to Φ^{g}, namely, S_{incoming}^{g} is the set of neuron groups immediately upstream to Φ^{g} (for example, S_{incoming}^{g}={Φ^{x}, Φ^{y}} in FIG. 4.), then:

$${i}_{j}^{g} = {b}_{j}^{g} + {\sum }_{{g}^{′} ∈ {S}_{incoming}^{g}} ( {\sum }_{k = 0}^{{n}^{{g}^{′}} - 1} {w}_{k , j}^{{g}^{′} \to g} \cdot {o}_{k}^{{g}^{′}} ) , \qquad ( 1 )$$

where w_{j,k}^{g′→g}, commonly called a weight, is a measure of a significance of the (k+1)^{th} sending neuron of group Φ^{g′} to the (j+1)^{th} receiving neuron of group Φ^{g}. For each receiving neuron, a weighted sum of the sending values is moderated by bⱼ^{g}, commonly called the bias, that controls how much the particular neuron skews the received weighted sum.

Eq. (1), disclosed above, can be rewritten for an entire neuron group Φ^{g} as

$${I}^{g} = {B}^{g} + {\sum }_{{g}^{′} ∈ {S}_{incoming}^{g}} {( {W}^{{g}^{′} \to g} )}^{T} \cdot {O}^{{g}^{′}} , \\ where$$

$${I}^{g} = {[ {i}_{0}^{g} , {i}_{1}^{g} , … , {i}_{{n}^{g} - 1}^{g} ]}^{T} , \\ {O}^{{g}^{′}} = {[ {o}_{0}^{{g}^{′}} , {o}_{1}^{{g}^{′}} , … , {o}_{{n}^{{g}^{′}} - 1}^{{g}^{′}} ]}^{T} , \\ {B}^{g} = {[ {b}_{0}^{g} , {b}_{1}^{g} , … , {b}_{{n}^{g} - 1}^{g} ]}^{T} , {and ( {W}^{{g}^{′} \to g} )}^{T} = [ \begin{matrix}{w}_{0 , 0}^{{g}^{′} \to g} & … & {w}_{{n}^{{g}^{′}} - 1 , 0}^{{g}^{′} \to g} \\ & ⋮ & \\ {w}_{0 , {n}^{g} - 1}^{{g}^{′} \to g} & … & {w}_{{n}^{{g}^{′}} - 1 , {n}^{g} - 1}^{{g}^{′} \to g}\end{matrix} ] .$$

The input and output vectors of the input and output neuron groups are similarly denoted by I^{input}, O^{input}, I^{output}, and O^{output}.

Training

High-Level Method Description

The weight matrices W^{g′→g} and bias vectors B^{g} used in forward propagation can be determined by (supervised) learning using a training set

$${S}_{training} = \{ \{ {I}_{T 0}^{input} , {O}_{{T}_{0}}^{output} \} , \{ {I}_{{T}_{1}}^{input} , {O}_{{T}_{1}}^{output} \} , … , \{ {I}_{{T}_{{n}_{samples} - 1}}^{input} , {O}_{{T}_{{n}_{samples} - 1}}^{output} \} \}$$

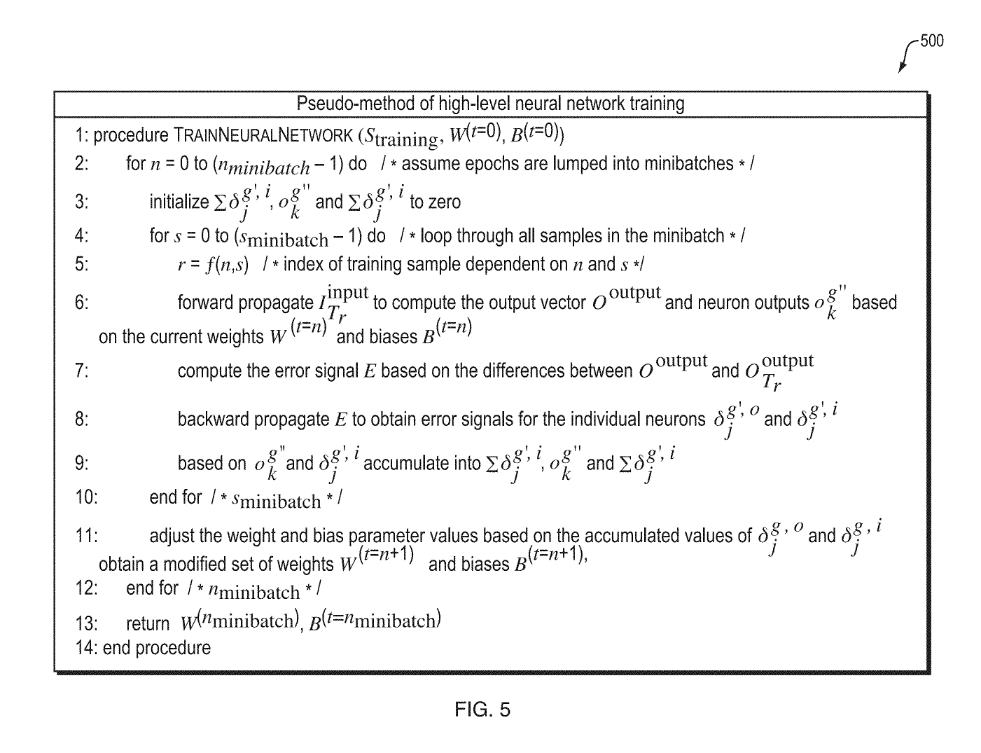

comprising nₛₐₘₚₗₑₛ pairs of input and output vectors. The weight and bias parameter values are defined iteratively as follows:
1. For each input-output vector pair {I_{T}_{ₛ}^{input}, O_{T}_{ₛ}^{output}}, forward propagate I_{T}_{ₛ}^{input} to compute the output vector O^{output} based on the current weights W^{(t)} and biases B^{(t)};
2. compute the error signal E based on the differences between O^{output} and O_{T}_{ₛ}^{output};
3. backward propagate E to obtain error signals for the individual neurons δⱼ^{g,o} and δⱼ^{g,i}, (as disclosed in Training—Backward Propagation, further below);
4. adjust the weight and bias parameter values based on the values of oₖ^{g″} and δⱼ^{g′,i} to obtain a modified set of weights W^{(t+1)} and biases B^{(t+1)}.
   It is customary to sum the error signals from multiple input-output vector pairs before adjusting the weights and biases. A collection of such vector pairs is called a minibatch, and the size of the minibatch, denoted by s_{minibatch}, is called the minibatch size. When s_{minibatch}>1, (1) to (3) are performed s_{minibatch} more times than (4), as disclosed in FIG. 5.

FIG. 5 is a listing 500 of an example embodiment of a pseudo-method of high-level neural network training.

Error Function

The error signal E may take on any suitable form. One such form expresses the error signal E as a summation of the individual error signals eⱼ from each output neuron, for example, the error signal E may take on the form:

$$E = {\sum }_{j = 0}^{{n}^{output} - 1} {e}_{j} . \qquad ( 2 )$$

Furthermore, each eⱼ is dependent only on the output and target values of the output neuron Øⱼ^{output}, namely,

eⱼ=fₑᵣᵣₒᵣ(tⱼ, oⱼ^{output}), where j∈{0, 1 . . . n^{output}−1} (3)

One of the two commonly-used functions that satisfies Eqs. (2) and (3) is relative entropy:

$$\begin{matrix}E = {\sum }_{j = 0}^{{n}^{output} - 1} {e}_{j} \\ = D ( {O}_{{T}_{s}}^{output} \vert \vert {O}^{output} ) \\ = {\sum }_{j = 0}^{{n}^{output} - 1} {t}_{j} log \frac{{t}_{j}}{{o}_{j}^{output}} ,\end{matrix}$$

where D(O_{T}_{ₛ}^{output}∥O^{output}) is the relative entropy function and O_{T}_{ₛ}^{output}={t₀t₁, . . . , tₙ_{^{output}}₋₁}. With this error function, the sensitivity of eⱼ with respect to oⱼ^{output} is:

$$\begin{matrix}\frac{\partial {e}_{j}}{\partial {o}_{j}^{output}} = \frac{\partial {f}_{error} ( {t}_{j} , {o}_{j}^{output} )}{\partial {o}_{j}^{output}} \\ = - \frac{{t}_{j}}{{o}_{j}^{output}} .\end{matrix} \qquad ( 4 )$$

A drawback of Eq. (4) is that output neurons with tⱼ=0 do not contribute to the error. To include such zero-valued output neurons, the complementary relative entropy error function can be used:

$$E = {\sum }_{j = 0}^{{n}^{output} - 1} [ {t}_{j} log \frac{{t}_{j}}{{o}_{j}^{output}} + ( 1 - {t}_{j} ) log \frac{1 - {t}_{j}}{1 - {o}_{j}^{output}} ] ,$$

and the associated error sensitivity becomes:

$$\frac{\partial {e}_{j}}{\partial {o}_{j}^{output}} = - \frac{{t}_{j}}{{o}_{j}^{output}} + \frac{1 - {t}_{j}}{1 - {o}_{j}^{output}} . \qquad ( 5 )$$

Training—Backward Propagation

Given an error signal E expressed in the form of Eq. (4) or Eq. (5), the sensitivity of E with respect to a particular weight w_{k,j}^{g′→output} (for a group Φ^{g′}ϵ S_{incoming}^{output}) may be expressed as:

$$\begin{matrix}\frac{\partial E}{\partial {w}_{k , j}^{{g}^{′} \to output}} = \frac{\partial {e}_{j}}{\partial {w}_{k , j}^{{g}^{′} \to output}} \\ = \frac{\partial {e}_{j}}{\partial {o}_{j}^{output}} \cdot \frac{\partial {o}_{j}^{output}}{\partial {i}_{j}^{output}} \cdot \frac{\partial {i}_{j}^{output}}{\partial {w}_{k , j}^{{g}^{′} \to output}} \\ = \frac{\partial {e}_{j}}{\partial {o}_{j}^{output}} \cdot \frac{\partial {o}_{j}^{output}}{\partial {i}_{j}^{output}} \cdot {o}_{k}^{{g}^{′}} ,\end{matrix} \qquad ( 6 )$$

where (∂oⱼ^{output}/∂iⱼ^{output}) is activation-function-dependent. For the common activation functions listed in the Neuron Activation section, disclosed above,

$$\begin{matrix}\frac{\partial {o}_{j}^{output}}{\partial {i}_{j}^{output}} = {o}_{j}^{output} \cdot ( 1 - {o}_{j}^{output} ) & for {f}^{output} = {f}_{sigmoid} , \\ = {o}_{j}^{output} \cdot ( 1 - {o}_{j}^{output} ) & for {f}^{output} = {f}_{softmax} , \\ = \{ \begin{matrix}0 & if {o}_{j}^{output} < 0 \\ 1 / 2 & if {o}_{j}^{output} = 0 \\ 1 & if {o}_{j}^{output} > 0\end{matrix} & for {f}^{output} = {f}_{ReLU} , \\ = 1 & for {f}^{output} = {f}_{identity} ,\end{matrix}$$

and the exact expression for ∂eⱼ/∂oⱼ^{output} is disclosed in the Error Function section, above.

The sensitivity of the error with respect to the bias bⱼ^{output} is:

$$\begin{matrix}\frac{\partial E}{\partial {b}_{j}^{output}} = \frac{\partial {e}_{j}}{\partial {b}_{j}^{output}} \\ = \frac{\partial {e}_{j}}{\partial {o}_{j}^{output}} \cdot \frac{\partial {o}_{j}^{output}}{\partial {i}_{j}^{output}} \cdot \frac{\partial {i}_{j}^{output}}{\partial {b}_{j}^{output}} \\ = \frac{\partial {e}_{j}}{\partial {o}_{j}^{output}} \cdot \frac{\partial {o}_{j}^{output}}{\partial {i}_{j}^{output}} .\end{matrix} \qquad ( 7 )$$

By defining the following:

$${δ}_{j}^{g , o} = \frac{\partial E}{\partial {o}_{j}^{g}} error sensitivity with respect to {o}_{j}^{g} , and$$

$$\begin{matrix}{δ}_{j}^{g , i} = \frac{\partial E}{\partial {i}_{j}^{g}} \\ = {δ}_{j}^{g , o} \cdot \frac{\partial {o}_{j}^{g}}{\partial {i}_{j}^{g}} error sensitivity with respect to {i}_{j}^{g} ,\end{matrix}$$

Eqs. (6) and (7) can be re-written as:

$$\frac{\partial E}{\partial {w}_{k , j}^{{g}^{′} \to output}} = {δ}_{j}^{output , i} \cdot {o}_{k}^{{g}^{′}} and$$

$$\frac{\partial E}{\partial {b}_{j}^{output}} = {δ}_{j}^{output , i} .$$

Now assuming s_{outgoing}^{g′}={Φ^{output}}, namely, Φ^{g′} sends only to Φ^{output}, then:

$$\begin{matrix}{δ}_{k}^{{g}^{′} , o} = \frac{\partial E}{\partial {o}_{k}^{{g}^{′}}} \\ = {\sum }_{j = 0}^{{n}^{output} - 1} \frac{\partial {e}_{j}}{\partial {o}_{j}^{output}} \frac{\partial {o}_{j}^{output}}{\partial {i}_{j}^{output}} \frac{\partial {i}_{j}^{output}}{\partial {o}_{k}^{{g}^{′}}} \\ = {\sum }_{j = 0}^{{n}^{output} - 1} {δ}_{j}^{output , i} \cdot {w}_{k , j}^{{g}^{′} \to output} ,\end{matrix}$$

$$and$$

$${δ}_{k}^{{g}^{′} , i} = {δ}_{k}^{{g}^{′} , o} \cdot \frac{\partial {o}_{k}^{{g}^{′}}}{\partial {i}_{k}^{{g}^{′}}} .$$

The sensitivity of the error with respect to the bias bₖ^{g′} is, thus,

$$\begin{matrix}\frac{\partial E}{\partial {b}_{k}^{{g}^{′}}} = {\sum }_{j = 0}^{{n}^{output} - 1} \frac{\partial {e}_{j}}{\partial {o}_{j}^{output}} \cdot \frac{\partial {o}_{j}^{output}}{\partial {i}_{j}^{output}} \cdot \frac{\partial {i}_{j}^{output}}{\partial {o}_{k}^{{g}^{′}}} \cdot \frac{\partial {o}_{k}^{{g}^{′}}}{\partial {i}_{k}^{{g}^{′}}} \cdot \frac{\partial {i}_{k}^{{g}^{′}}}{\partial {b}_{k}^{{g}^{′}}} \\ = {δ}_{k}^{{g}^{′} , i} ,\end{matrix} \qquad ( 8 )$$

for a group Φ^{g″} such that Φ^{g″}ϵ S_{incoming}^{g′} is:

$$\begin{matrix}\frac{\partial E}{\partial {w}_{m , k}^{{g}^{″} \to {g}^{′}}} = {\sum }_{m = 0}^{{n}^{output} - 1} \frac{\partial {e}_{j}}{\partial {o}_{j}^{output}} \cdot \frac{\partial {o}_{j}^{output}}{\partial {i}_{j}^{output}} \cdot \frac{\partial {i}_{j}^{output}}{\partial {o}_{k}^{{g}^{′}}} \cdot \frac{\partial {o}_{k}^{{g}^{′}}}{\partial {i}_{k}^{{g}^{′}}} \cdot \frac{\partial {i}_{k}^{{g}^{′}}}{\partial {w}_{m , k}^{{g}^{″} \to {g}^{′}}} \\ = {δ}_{k}^{{g}^{′} , i} \cdot {o}_{m}^{{g}^{″}} .\end{matrix} \qquad ( 9 )$$

No special treatment was given to quantities related to Φ^{output} in the derivation of Eqs. (8) and (9). They are, thus, general equations relating values of δᵢ^{g′,i} and δᵢ^{g′,o} between connected neuron groups. Rewriting Eqs. (8) and (9) to remove Φ^{output}-specific references, the following general set of back propagation equations may be arrived at:

$$\begin{matrix}\frac{\partial E}{\partial {w}_{k , j}^{{g}^{″} \to {g}^{′}}} = {δ}_{j}^{{g}^{′} , i} \cdot {o}_{k}^{{g}^{″}} , & ( 10 ) \\ \frac{\partial E}{\partial {b}_{j}^{{g}^{′}}} = {δ}_{j}^{{g}^{′} , i} \cdot {δ}_{j}^{{g}^{′} , o} \cdot \frac{\partial {o}_{j}^{{g}^{′}}}{\partial {i}_{j}^{{g}^{′}}} , \\ where & ( 11 ) \\ {δ}_{j}^{{g}^{′} , i} = {δ}_{j}^{{g}^{′} , o} \cdot \frac{\partial {o}_{j}^{g}}{\partial {i}_{j}^{{g}^{′}}} and \\ {δ}_{j}^{{g}^{′} , o} = {\sum }_{g ∈ {S}_{outgoing}^{{g}^{′}}} ( {\sum }_{m = 0}^{{n}^{g} - 1} {δ}_{m}^{g , i} \cdot {w}_{j , m}^{{g}^{′} \to g} ) , & ( 12 )\end{matrix}$$

with S_{outgoing}^{g′} being the set of neuron groups that receive values from Φ^{g′}. As a result, the adjustments made to the weights and biases are:

$$Δ {w}_{k , j}^{{g}^{″} \to {g}^{′}} = - {α}_{w} {\sum }_{{s}_{minibatch}} {δ}_{j}^{{g}^{′} , i} \cdot {o}_{k}^{{g}^{″}} and \\ Δ {b}_{j}^{{g}^{′}} = - {α}_{b} {\sum }_{{s}_{minibatch}} {δ}_{j}^{{g}^{′} , i} = - {α}_{b} {\sum }_{{s}_{minibatch}} {δ}_{j}^{{g}^{′} , o} \cdot \frac{\partial {o}_{j}^{{g}^{′}}}{\partial {i}_{j}^{{g}^{′}}} , \qquad ( 13 )$$

where α_{w} and α_{b} are the learning rates for weights and biases, respectively. These learning rates can vary between weights in a weight matrix and between neurons in a neuron group. To simplify the exposition, α_{w} is assumed to be the same for all weights and α_{b} is assumed to be the same for all biases, although these assumptions do not affect the generality of this disclosure.

Fixed-Point Implementation

Forward Propagation

The forward propagation variables as expressed in Eq. (1) above are real-valued. According to an example embodiment, to improve throughput and to reduce memory usage, forward propagation may be performed using fixed-point variables, such that the actual implementation is a modification of Eq. (1):

$$\hat{{i}_{j}^{g}} = \hat{{b}_{j}^{g}} + {\sum }_{{g}^{′} ∈ {S}_{incoming}^{g}} ( {\sum }_{k = 0}^{{n}^{{g}^{′} - 1}} {w}_{k , j}^{\hat{{g}^{′}} \to g} \cdot {o}_{k}^{\hat{{g}^{′}}} ) , \qquad ( 14 )$$

where iⱼ^{ĝ}, bⱼ^{ĝ}, [symbol] , and oₖ^{ĝ′} are integers. The relation between these integer-valued variables and the original real-valued ones are:

b′ⱼ^{g}=round(s_{b}^{g}·bⱼ^{g})

w_{k,j}^{g′→g}=round(s_{w}^{g′→g}·w_{k,j}^{g′→g})

oₖ^{g′}=round(sₒ^{g′}·oₖ^{g′}).

where sₒ^{g′} and s_{b}^{g} are, respectively, scaling factors for the real-valued variables oₖ^{g′} and bⱼ^{g}; s_{w}^{g′→g} is the scaling factor for the weights connecting Φ^{g′} and Φ^{g}; and round (·) is a function that rounds its argument to an integer. As written, Eq. (14) imposes the following constraints between the scaling factors:

sₒ^{g′}·s_{w}^{g′→g}=s_{b}^{g}=sᵢ^{g}, (15)

such that:

iⱼ^{ĝ} [symbol] round(sᵢ^{g}·iⱼ^{g}),

where sᵢ^{g} is the scaling factor for the real-valued variable iⱼ^{g}. The constraints expressed in Eq. (15), however, are not strictly necessary, although, for expositional clarity, these constraints are proceeded with to obviate introduction of parameters that are non-central to such disclosure.

The variables iⱼ^{ĝ, b}ⱼ^{ĝ}, [symbol] , and oₖ^{ĝ′} can be implemented as 16-bit, 8-bit, or, any other suitable n-bit integers, such as 1-bit integers. Such implementation is beneficial not only for reduced memory footprint, as real-valued variables may take up 32 bits, such as for single-precision floating-point variables, or 64 bits, such as for double-precision floating-point variables, but also for high-throughput computation as one can take advantage of single-instruction multiple-data (SIMD) instruction sets, such as Intel® Streaming SIMD Extensions (Intel® SSE).

Backward Propagation

Since fixed-point computation has demonstrated tremendous benefits in throughput, reduced memory usage, and precision for forward propagation, an example embodiment may implement similar for backward propagation by transforming Eqs. (12)-(13) into some fixed-point counterpart such as:

$$\begin{matrix}{δ}_{j}^{\hat{{g}^{′}} , i} = {δ}_{j}^{\hat{{g}^{′}} , o} \cdot \frac{\partial {o}_{j}^{\hat{{g}^{′}}}}{\partial {i}_{j}^{\hat{{g}^{′}}}} , \\ {δ}_{j}^{\hat{{g}^{′}} , o} = {\sum }_{g ∈ {S}_{outgoing}^{{g}^{′}}} ( {\sum }_{m = 0}^{{n}^{g} - 1} {δ}_{m}^{\hat{g} , i} \cdot {w}_{j , m}^{\hat{{g}^{′}} \to g} ) , \\ Δ {w}_{k , j}^{\hat{{g}^{″}} \to {g}^{′}} = - round ( {α}_{w} {\sum }_{{s}_{minibatch}} {δ}_{j}^{\hat{{g}^{′}} , i} \cdot {o}_{k}^{\hat{{g}^{″}}} ) , and & ( 16 ) \\ Δ {\hat{b}}_{j}^{{g}^{′}} = - round ( {α}_{b} {\sum }_{{s}_{minibatch}} {δ}_{j}^{\hat{{g}^{′}} , i} ) , \\ where \\ {i}_{j}^{{\hat{g}}^{′}} = {s}_{i}^{{g}^{′}} \cdot {i}_{j}^{{g}^{′}} , \\ {o}_{j}^{{\hat{g}}^{′}} = {s}_{o}^{{g}^{′}} \cdot {o}_{j}^{{g}^{′}} , \\ {w}_{j , m}^{\hat{{g}^{′}} \to g} = {s}_{w}^{{g}^{′} \to g} \cdot {w}_{j , m}^{{g}^{′} \to g} , \\ Δ {w}_{k , j}^{\hat{{g}^{″}} \to {g}^{′}} = round ( {s}_{w}^{{g}^{″} \to {g}^{′}} \cdot Δ {w}_{k , j}^{{g}^{″} \to {g}^{′}} ) , \\ Δ {\hat{b}}_{j}^{{g}^{′}} = round ( {s}_{b}^{{g}^{′}} \cdot Δ {b}_{j}^{{g}^{′}} ) , \\ {δ}_{j}^{\hat{{g}^{′}} , i} = {s}_{{δ}^{i}}^{{g}^{′}} \cdot {δ}_{j}^{{g}^{′} , i} , \\ {δ}_{j}^{\hat{{g}^{′}} , o} = {s}_{{δ}^{o}}^{{g}^{′}} \cdot {δ}_{j}^{{g}^{′} , o} , & ( 17 )\end{matrix}$$

and {sᵢ^{g′}, sₒ^{g″}, s_{w}^{g′→g}, s_{w}^{g″→g″}, s_{b}^{g′}, s_{δi}^{g′}, s_{δo}^{g′}} is some set of scaling factors. Nevertheless, a straightforward (unsophisticated) conversion such as that expressed in Eqs. (16) and (17) does not achieve advantages in speed, memory usage, and precision as compared with a floating-point implementation for back propagation. For example, the rounding operations in these equations would render the integer-valued incremental changes Δw_{k,j}^{ĝ′→g′} and Δ\hat{b}ⱼ^{g′} too coarse for effective learning. In addition, depending on the scaling factors, precision of the quantities δⱼ^{ĝ′,i} and oₖ^{ĝ″} may be inadequate for proper determination of Δw_{k,j}^{ĝ″→g′} and Δ\hat{b}ⱼ^{g′}.

Considering propagation between two groups Φ^{g″} and Φ^{g′}, where Φ^{g″} is immediately upstream to Φ^{g′}. and given forward propagation scaling factors s_{b}^{g″}, s_{w}^{g″→g′}, and sₒ^{g″}, and the following constraints relating them to the backward propagation scaling factors s_{δi}^{g′}, s_{δo}^{g′}, and s_{δo}^{g″}, according to an example embodiment:

sₒ^{g″}·s_{δi}^{g′}=m_{w}^{precision}·s_{w}^{g″→g′}, m_{w}^{precision}>1, (18)

s_{δo}^{g″}=m_{b}^{precision}·s_{b}^{g″}, and m_{b}^{precision}>1, (19)

where m_{w}^{precision} and m_{b}^{precision} are a weight multiplying factor and a bias multiplying factor, respectively. The following set of first-pass fixed-point back propagation equations are presented according to an example embodiment:

$$\begin{matrix}{δ}_{j}^{\hat{{g}^{′}} , i} = round ( {s}_{{δ}^{i}}^{{g}^{′}} \cdot \frac{{δ}_{j}^{\hat{{g}^{′}} , o}}{{s}_{{δ}^{o}}^{{g}^{′}}} \cdot \frac{\partial {o}_{j}^{{g}^{′}}}{\partial {i}_{j}^{{g}^{′}}} ) , \\ {δ}_{j}^{\hat{{g}^{″}} , o} = \frac{{s}_{{δ}^{o}}^{{g}^{″}}}{{s}_{{δ}^{i}}^{{g}^{′}} \cdot {s}_{w}^{{g}^{″} \to {g}^{′}}} ( {\sum }_{m = 0}^{{n}^{g} - 1} {δ}_{m}^{\hat{{g}^{′}} , i} \cdot {w}_{j , m}^{\hat{{g}^{″}} \to {g}^{′}} ) , & ( 20 ) \\ \begin{matrix}Δ {w}_{k , j}^{\hat{{g}^{″}} \to {g}^{′}} = - round ( {α}_{w} \cdot {s}_{w}^{{g}^{″} \to {g}^{′}} {\sum }_{{s}_{minibatch}} [ \frac{{δ}_{j}^{\hat{{g}^{′}} , i}}{{s}_{{δ}^{i}}^{{g}^{′}}} \cdot \frac{{o}_{k}^{\hat{{g}^{″}}}}{{s}_{o}^{{g}^{″}}} ] ) \\ = - round ( \frac{{α}_{w}}{{m}_{w}^{preision}} {\sum }_{{s}_{minibatch}} {δ}_{j}^{\hat{{g}^{′}} , i} \cdot {o}_{k}^{\hat{{g}^{″}}} ) ,\end{matrix} & ( 21 ) \\ \begin{matrix}Δ {b}_{j}^{\hat{{g}^{″}}} = - round ( {α}_{b} \cdot {s}_{b}^{{g}^{″}} {\sum }_{{s}_{minibatch}} [ \frac{{δ}_{j}^{\hat{{g}^{″}} , o}}{{s}_{{δ}^{o}}^{{g}^{″}}} \cdot \frac{\partial {o}_{j}^{{g}^{″}}}{\partial {i}_{j}^{{g}^{″}}} ] ) \\ = - round ( \frac{{α}_{b}}{{m}_{b}^{preision}} {\sum }_{{s}_{minibatch}} {δ}_{j}^{\hat{{g}^{″}} , o} \cdot \frac{\partial {o}_{j}^{{g}^{″}}}{\partial {i}_{j}^{{g}^{″}}} ) .\end{matrix} & ( 22 )\end{matrix}$$

It should be understood that the right hand side of Eq. (20) should be preceded by the summation

$${\sum }_{{g}^{′} ∈ {S}_{outgoing}^{{g}^{″}}} ,$$

which has been omitted for expositional clarity as it does not affect disclosure of the example embodiment of a fixed-point backward propagation method. Since, by the constraints expressed in Eqs. (18) and (19), m_{w}^{precision}>m_{b}^{precision}>1, the weight and bias adjustments Δw_{k,j}^{ĝ″→g′} and Δ\hat{b}ⱼ^{g′} in Eqs. (21) and (22) may be obtained from quantities of higher precision. In fact, the error signals

$${\sum }_{{s}_{minibatch}} \frac{{δ}_{j}^{\hat{{g}^{′}} , i} \cdot {o}_{k}^{\hat{{g}^{″}}}}{{m}_{w}^{precision}} and {\sum }_{{s}_{minibatch}} \frac{{δ}_{j}^{\hat{{g}^{′}} , o}}{{m}_{b}^{precision}} \cdot \frac{\partial {o}_{j}^{{g}^{′}}}{\partial {i}_{j}^{{g}^{′}}}$$

can be made arbitrarily precise by increasing m_{w}^{precision} and m_{b}^{precision}, and the rounding operations in Eqs. (21) and (22) would become ever more the dominant cause of the deviation of fixed-point backward propagation from floating-point, assuming forward propagation quantities such as i_{jĝ′} and oₖ^{ĝ″} are the same for both floating-point and fixed-point backward propagation computation. Under this situation, truncation errors due to rounding may accumulate from minibatch to minibatch, leading to large discrepancies in the eventual trained neural network models between floating-point and fixed-point implementations.

According to an example embodiment, truncation errors can be satisfactorily eliminated by keeping track of them and incorporating them as part of the weight and bias adjustments during each minibatch update, resulting in the following set of fixed-point back propagation equations:

$$\begin{matrix} {δ}_{j}^{\hat{{g}^{′}} , i} = round ( {s}_{{δ}^{i}}^{{g}^{′}} \cdot \frac{{δ}_{j}^{\hat{{g}^{′}} , o}}{{s}_{{δ}^{o}}^{{g}^{′}}} \cdot \frac{\partial {o}_{j}^{{g}^{′}}}{\partial {i}_{j}^{{g}^{′}}} ) , & ( 23 ) \\ {δ}_{j}^{\hat{{g}^{″}} , o} = \frac{{s}_{{δ}^{o}}^{{g}^{″}}}{{s}_{{δ}^{i}}^{{g}^{′}} \cdot {s}_{w}^{{g}^{″} \to {g}^{′}}} ( {\sum }_{m = 0}^{{n}^{g} - 1} {δ}_{m}^{\hat{{g}^{′}} , i} \cdot {w}_{j , m}^{\hat{{g}^{″}} \to {g}^{′}} ) , & ( 24 ) \\ Δ {w}_{k , j}^{\hat{{g}^{″}} \to {g}^{′} , ( t )} = - round ( \frac{{α}_{w}}{{m}_{w}^{precision}} [ δ {w}_{k , j}^{{g}^{″} \to {g}^{′} , ( t )} + {\sum }_{{s}_{minibatch}} {δ}_{j}^{\hat{{g}^{′}} , i} \cdot {o}_{k}^{\hat{{g}^{″}}} ] ) , & ( 25 ) \\ Δ {b}_{j}^{\hat{{g}^{″}} , ( t )} = - round ( \frac{{α}_{b}}{{m}_{b}^{precision}} [ δ {b}_{j}^{{g}^{″} , ( t )} + {\sum }_{{s}_{minibath}} {δ}_{j}^{\hat{{g}^{″}} , o} \cdot \frac{\partial {o}_{j}^{{g}^{″}}}{\partial {i}_{j}^{{g}^{″}}} ] ) , & ( 26 ) \\ δ {w}_{k , j}^{{g}^{″} \to {g}^{′} , ( t + 1 )} = {δ}_{j}^{\hat{{g}^{′}} , i} \cdot {o}_{k}^{\hat{{g}^{″}}} - {m}_{w}^{precision} \cdot \frac{Δ {w}_{k , j}^{\hat{{g}^{″}} \to {g}^{′} , ( t )}}{{α}_{w}} + δ {w}_{k , j}^{{g}^{″} \to {g}^{′} , ( t )} , & ( 27 ) \\ δ {b}_{j}^{{g}^{′} , ( t + 1 )} = {δ}_{j}^{{g}^{′} , o} \cdot \frac{\partial {o}_{j}^{\hat{{g}^{′}}}}{\partial {i}_{j}^{\hat{{g}^{′}}}} - {m}_{b}^{precision} \cdot \frac{Δ {b}_{j}^{\hat{{g}^{′}} , ( t )}}{{α}_{b}} + δ {b}_{j}^{{g}^{′} , ( t )} , & ( 28 ) \\ δ {w}_{k , j}^{{g}^{″} \to {g}^{′} , ( 0 )} = 0 , & ( 29 ) \\ δ {b}_{j}^{{g}^{′} , ( 0 )} = 0. & ( 30 )\end{matrix}$$

There remains the matter of setting values for the multiplying factors and scaling factors. Assuming that the forward propagation scaling factors s_{b}^{g″}, s_{w}^{g″→g}, and sₒ^{g″} are given in advance, the values for m_{w}^{precision} m_{b}^{precision}, s_{δ}_{ᵢ}^{g′}, and s_{δo}^{g″} may be determined as follows, according to an example embodiment:
1. Set a maximum value for s_{δo}^{g″} considering numerical overflow. For example, if δⱼ^{ĝ″o} is stored as a 32-bit integer, max(s_{δo}^{g″}) can be set to 10⁸.
2. s_{δi}^{g″=[max(s}_{δo}^{g″})s_{w}^{g″→g′}],
3. s_{δo}^{g″=s}_{w}^{g″→g}″·s_{δi}^{g″},
4. m_{w}^{precision}=(sₒ^{g″}·s_{δi})/s_{w}^{g″→g′}, and
5. m_{b}^{precision}=s_{δo}^{g″}/s_{b}^{g″.}
   This has the additional speed advantage that the first term on the right hand side of Eq. (24) is 1 and can be removed from computation. As such, an example embodiment of a method for training a digital computational learning system, such as the example embodiment of the method of FIG. 2, disclosed above, may comprise computing multiplying factors, such as the weight multiplying factor m_{w}^{precision} and the bias multiplying factor m_{b}^{precision}, disclosed above, and a first and second back propagation scaling factor, such as sδi^{g″and s}_{δo}^{g″}, disclosed above, based on a first, second, and third forward propagation scaling factor, such as the forward propagation scaling factors s_{b}^{g″}, s_{w}^{g′→g}, and sₒ^{g″}, respectively, disclosed above.

According to an example embodiment, computing the multiplying factors, namely m_{w}^{precision} and m_{b}^{precision}. and the first and second back propagation scaling factors, namely, s_{δi}^{g′} and s_{δo}^{g″}, respectively, may include setting a maximum scaling factor value based on a numerical overflow constraint. For example, the maximum scaling factor value for the second back propagation scaling factor s_{δo}^{g″} may set to 10⁸ based on storing the second back propagation scaling factor s_{δo}^{g″} as a 32-bit integer. It should be understood that the maximum scaling factor value may set to any suitable value that is based on any suitable numerical overflow constraint.

According to an example embodiment, computing the first back propagation scaling factor s_{δi}^{g′} may be based on a first ratio of the maximum scaling factor value to the second forward propagation scaling factor s_{w}^{g″→g}, such as the first ratio, [max(s_{δo}^{g″})/s_{w}^{g″→g′}], disclosed above. Computing the second back propagation scaling factor s_{δo}^{g″} may be based on a first product of the second forward propagation scaling factor s_{w}^{g″→g} and the first back propagation scaling factor s_{δi}^{g′} computed. Computing the weight multiplying factor mₘ^{precision} may be based on a second ratio of a second product of the third forward propagation scaling factor sₒ^{g″} and the first back propagation scaling factor s_{δi}^{g′} computed to the second forward propagation factor s_{w}^{g′→g}, such as the second ratio (sₒ^{g″}·s_{δ″}^{g″}/n_{b}^{g″→g″}, disclosed above. Computing the bias multiplying factor m_{b}^{precision} may be based on a third ratio of the second back propagation scaling factor s_{δo}^{g″} computed to the first forward propagation scaling factor s_{b}^{g″}, such as the third ratio s_{δi}^{g″}, and s_{δo}^{″}, disclosed above. The first, second, and third forward propagation scaling factors and the first and second back propagation scaling factors may enable conversion of values of the one or more finer granularities to the coarser granularity. According to an example embodiment, the one or more finer granularities may include double-precision floating-point and the coarser granularity may be 16-bit fixed-point.

According to another example embodiment, the values for m_{w}^{precision}, m_{b}^{precision}, s_{δi}^{g′}, and s_{δo}^{g″} may be determined as follows:
1. Determine m_{b}^{precision} based on the following two constraints,
   (a) m_{b}^{precision}>1 and
   (b) (m_{b}^{precision}·s_{b}^{g″}·sₒ^{g″})/(s_{w}^{g″→g′}) is an integer.
2. m_{w}^{precision}=(m_{b}^{precision}·s_{b}^{g″}·sₒ^{g″})/(s_{w}^{g″→g′})²,
3. s_{δo}^{g″}=m_{b}^{precision}·s_{b}^{g″}.
4. s_{δi}^{g′}=s_{δo}^{g″}/s_{w}^{g″→g′}.
   This would guarantee s_{δo}^{g″}=s_{w}^{g″→g′}·s_{δi}^{g′}, thus resulting in the same additional speed-up as in the previous embodiment. As such, an example embodiment of a method for training a digital computational learning system, such as the example embodiment of the method of FIG. 2, disclosed above, may comprise setting the bias multiplying factor m_{b}^{precision} based on at least two constraints.

The at least two constraints may include (a) constraining the bias multiplying factor m_{b}^{precision} to a value greater than one and (b) constraining a first ratio to an integer. The first ratio may be computed based on the bias multiplying factor m_{b}^{precision} and the first, second, and third forward propagation scaling factors s_{b}^{g′}, s_{w}^{g″→g}, and sₒ^{g″}respectively, disclosed above. The first ratio may relate a first product to the second forward propagation scaling factor s_{w}^{g″→g} squared. The first product may be produced by multiplying the bias multiplying factor m_{b}^{precision} with the first and third forward propagation scaling factors s_{b}^{g″} and sₒ^{9″}, respectively. The method may comprise computing the weight multiplying factor m_{w}^{precision} by computing the first ratio, such as the first ratio (m_{b}^{precision}, s_{b}^{g″, s}_{g″})/(s_{w}^{g″→g″})², disclosed above.

The method may comprise computing the first and second back propagation scaling factors, s_{δi}^{g′} and s_{δo}^{g″}, respectively, wherein the second back propagation scaling factor s_{δo}^{g″}may be computed based on a second product of the bias multiplying factor m_{b}^{precision} and the first forward propagation factor s_{b}^{g″}, such as the second product m_{b}^{precision}·s_{b}^{g″}. The first back propagation scaling factor s_{δi}^{g′}, may be based on a second ratio of the second back propagation scaling factor s_{δo}^{g″} computed to the second forward propagation scaling factor s_{w}^{g″→g}, such as the second ratio s_{δo}^{g″/δ}_{w}^{g″→g″.}

Numerical Results

The fixed-point back propagation equations, Eqs. (23) to (30), disclosed above, have been implemented, and their robustness verified via an adaptation application. The word-error-rate (WER) of the speaker-independent model is 5.85%. Using one hour of audio data, the WER for double-precision floating-point adaptation is 5.34%, compared with 5.33% for a 16-bit fixed-point adaptation according to an example embodiment disclosed herein.

From profiling of an Intel® SSE implementation on a dual-processor Intel® Xeon® 2.26 GHz machine with 12 GB of memory running a 64-bit Windows® 7 operating system, 16-bit fixed-point propagation, according to example embodiments disclosed herein, gives a speedup factor of 5.5 compared with double-precision floating-point. Each back propagation stage takes 30232 cycles for fixed-point computation, as opposed to 166784 cycles for floating-point, averaged over 761064 stages. The additional observed speedup beyond the expected 4× is likely the result of more compact memory footprint.

Another advantage of fixed-point back propagation, according to example embodiments disclosed herein, is numerical precision. There is no difference in results across different compute platforms, such as desktop, laptop, smart phone, or any other suitable compute platform.

As disclosed above, it should be understood that embodiments disclosed herein are not limited to neural network applications, fixed-point implementation, or back propagation. Embodiments disclosed herein may be applied to various types of digital learning systems, such as GMMs or clustering models, disclosed above. Embodiments disclosed herein may be applied to any training process of a learning system that may iteratively comprise a production phase, error determination phase, and update phase, as disclosed above. According to an example embodiment, the production phase may be computed in coarser granularity fixed-point arithmetic, for example, in a clustering model, the cluster centers may be represented as integers, while the location error of each cluster center may be computed in finer granularity relative to the coarser granularity. For example, given a cluster comprising two points with coordinates 2 and 5, then the cluster center may be given by the average of these two coordinates, which is equal to 3.5[finer granularity] rather than round ((2+5)/2)=4 [coarser granularity]. The cluster center may still be adjusted to 4, however, according to an example embodiment, accumulating the extra adjustment may be made as (3.5−4=−0.5) [finer granularity] into the accumulated residual error, to be used in a next iteration.

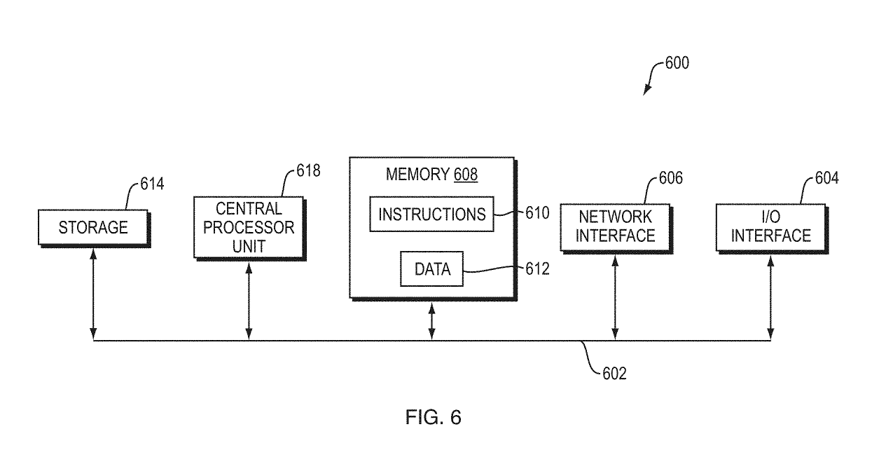

FIG. 6 is a block diagram of an example of the internal structure of a computer 600 in which various embodiments of the present disclosure may be implemented. The computer 600 contains a system bus 602, where a bus is a set of hardware lines used for data transfer among the components of a computer or processing system. The system bus 602 is essentially a shared conduit that connects different elements of a computer system (e.g., processor, disk storage, memory, input/output ports, network ports, etc.) that enables the transfer of information between the elements. Coupled to the system bus 602 is an I/O device interface 604 for connecting various input and output devices (e.g., keyboard, mouse, displays, printers, speakers, etc.) to the computer 600. A network interface 606 allows the computer 600 to connect to various other devices attached to a network. Memory 608 provides volatile or non-volatile storage for computer software instructions 610 and data 612 that may be used to implement embodiments of the present disclosure, where the volatile and non-volatile memories are examples of non-transitory media. Disk storage 614provides non-volatile storage for computer software instructions 610 and data 612 that may be used to implement embodiments of the present disclosure. A central processor unit 618is also coupled to the system bus 602 and provides for the execution of computer instructions.

Further example embodiments disclosed herein may be configured using a computer program product; for example, controls may be programmed in software for implementing example embodiments. Further example embodiments may include a non-transitory computer-readable medium containing instructions that may be executed by a processor, and, when loaded and executed, cause the processor to complete methods described herein. It should be understood that elements of the block and flow diagrams may be implemented in software or hardware, such as via one or more arrangements of circuitry of FIG. 6, disclosed above, or equivalents thereof, firmware, a combination thereof, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

Below is a Glossary of terms disclosed herein.

### Glossary

Φ^{g} neuron group g
i_{g} input value of (j+1)^{th} neuron in group Φ^{g}
f^{g}(iⱼ^{g}) neuron activation (transfer) function
oⱼ^{g} output value of (j+1) ₜₕ neuron in group Φ^{g}
bⱼ^{g} neuron bias: controls how much a particular neuron skews the received input
w_{k,j}^{g′→g} connection weight measures significant of the (k+1)^{th} sending neuron of group Φ^{g}″ to the (j+1)^{th} receiving neuron of group Φ^{g}
eⱼ error signal of the (j+1)^{th} neuron of the output neuron group
δⱼ^{g′,i} error (signal) sensitivity of the (j+1)^{th} neuron in group Φ^{g} with respect to iⱼ^{g}
δⱼ^{g′,o} error (signal) sensitivity with respect to oⱼ^{g}
Δw_{k,j}^{g″→g′}weight adjustment
α_{w} learning rate for weights
Δbⱼ^{g′}bias adjustment
α_{b} learning rate for biases
bⱼ^{ĝ} coarser granularity (e.g., 16-bit fixed-point) representation of bⱼ^{g}
w_{k,j}^{g″→g} coarser granularity (e.g., 16-bit fixed-point) representation of w_{k,j}^{g″→g}
iⱼ^{g} coarser granularity (e.g., 16-bit fixed-point) representation of iⱼ^{g}
oⱼ^{g′}coarser granularity (e.g., 16-bit fixed-point) representation of oⱼ^{g′}
δⱼ^{g′,i} coarser granularity e.g., 16-bit fixed-point) representation of δ_{g}^{j′,i}
δⱼ^{g′,o} coarser granularity (e.g., 16-bit fixed-point) representation of δⱼ^{g′,i}
sₒ^{g′} scaling factor relating variables in one or more finer granularities (e.g., double-precision floating-point) to variables in coarser-granularity (e.g., 16-bit fixed-point)
s_{w}^{g′→g} ditto
s_{b}^{g} ditto
67 ⱼ^{g} ditto
s_{δ′}^{g″} ditto
s₀^{g′}ditto
m_{w}^{precision} multiplying factor for weights; m_{w}^{precision}>1
m_{b}^{precision} multiplying factor for biases; m_{b}^{precision}>1
δw_{k,j}^{g″→g′,(t+1)} iteration-to-iteration weight accumulated error term in finer granularity (e.g., 32-bit fixed-point)
δbⱼ^{g′,(t+1)} iteration-to-iteration bias term in finer granularity (e.g., 32-bit fixed-point)

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method for training a digital computational learning system, the method comprising:
computing a sum of a present error term and an accumulated error term, the present error term being a function of an expected output and an actual output of the digital computational learning system to a given input in a present iteration of the training, the accumulated error term accumulated over previous iterations of the training, the present error term, accumulated error term, and the sum having a finer granularity relative to a coarser granularity of adjustable parameters within the digital computational learning system;
converting the sum to a converted sum having the coarser granularity;
adjusting the adjustable parameters as a function of the converted sum in the present iteration;
updating the accumulated error term, having the finer granularity, for use in adjusting the adjustable parameters, having the coarser granularity, in a next iteration of the training of the digital computational learning system, the updating including applying a difference between the converted sum and the sum, the difference having the finer granularity; and
wherein the computing, converting, adjusting, and updating improve a computational speed and reduce a memory usage of the digital computational learning system while maintaining an accuracy of the training relative to a different method of training the digital computational learning system, the different method based exclusively on one or more finer granularities finer than the coarser granularity.

2. The method of claim 1, wherein the digital computational learning system is a neural network.

3. The method of claim 2, wherein the neural network is a feed-forward neural network, convolutional neural network, recurrent neural network, or long short-term memory neural network.

4. The method of claim 2, wherein the neural network includes a back propagation stage, the back propagation stage including the computing, converting, adjusting, and updating.

5. The method of claim 2, wherein the adjustable parameters are connection weights between neurons and biases of neurons of the neural network and wherein the adjusting includes applying multiplying factors of value greater than one, the multiplying factors including a weight multiplying factor or a bias multiplying factor, and wherein the applying includes applying the weight multiplying factor to a connection weight parameter and the bias multiplying factor to a bias parameter.

6. The method of claim 5, further comprising computing the multiplying factors and a first and second back propagation scaling factor based on a first, second, and third forward propagation scaling factor, wherein computing the multiplying factors and the first and second back propagation scaling factors includes:
setting a maximum scaling factor value based on a numerical overflow constraint;
computing the first back propagation scaling factor based on a first ratio of the maximum scaling factor value to the second forward propagation scaling factor;
computing the second back propagation scaling factor based on a first product of the second forward propagation scaling factor and the first back propagation scaling factor computed;
computing the weight multiplying factor based on a second ratio of a second product of the third forward propagation scaling factor and the first back propagation scaling factor computed to the second forward propagation factor; and
computing the bias multiplying factor based on a third ratio of the second back propagation scaling factor computed to the first forward propagation scaling factor, wherein the first, second, and third forward propagation scaling factors and the first and second back propagation scaling factors enable conversion of values of the one or more finer granularities to the coarser granularity.

7. The method of claim 5, further comprising:
setting the bias multiplying factor based on at least two constraints, the at least two constraints including (a) constraining the bias multiplying factor to a value greater than one and (b) constraining a first ratio to an integer, the first ratio computed based on the bias multiplying factor and a first, second, and third forward propagation scaling factor, the first ratio relating a first product to the second forward propagation scaling factor squared, the first product produced by multiplying the bias multiplying factor with the first and third forward propagation scaling factors;
computing the weight multiplying factor by computing the first ratio;
computing a first and second back propagation scaling factor, wherein the second back propagation scaling factor is computed based on a second product of the bias multiplying factor and the first forward propagation factor and wherein the first back propagation scaling factor is based on a second ratio of the second back propagation scaling factor computed to the second forward propagation scaling factor; and
wherein the first, second, and third forward propagation scaling factors and the first and second back propagation scaling factors enable conversion of values of the one or more finer granularities to the coarser granularity.

8. The method of claim 1, wherein at least one processor composes the digital computational learning system.

9. The method of claim 1, wherein the given input is a digital representation of a voice, image, or signal and the method of claim 1 further includes employing the digital computational learning system in a speech recognition, image recognition, motion control, or communication application.

10. The method of claim 1, further including employing the digital computational learning system in a credit card, fraud detection, tax return, income level, foreign account, bank account, tax level, or health care application, or other application that distinguishes between sets of things.

11. A system for training a digital computational learning system, the system comprising;
at least one processor and at least one memory storing a sequence of instructions which, when loaded and executed by the at least one processor, configures the at least one processor to be the digital computational learning system and causes the at least one processor to:
compute a sum of a present error term and an accumulated error term, the present error term being a function of an expected output and an actual output of the digital computational learning system to a given input in a present iteration of the training, the accumulated error term accumulated over previous iterations of the training, the present error term, accumulated error term, and the sum having a finer granularity relative to a coarser granularity of adjustable parameters within the digital computational learning system;
convert the sum to a converted sum having the coarser granularity;
adjust the adjustable parameters as a function of the converted sum in the present iteration;
update the accumulated error term, having the finer granularity, for use in adjusting the adjustable parameters, having the coarser granularity, in a next iteration of the training of the digital computational learning system, the update operation including applying a difference between the converted sum and the sum, the difference having the finer granularity; and
wherein the compute, convert, adjust, and update operations improve a computational speed and reduce a memory usage of the digital computational learning system while maintaining an accuracy of the training relative to a different method of training the digital computational learning system, the different method based exclusively on one or more finer granularities finer than the coarser granularity.

12. The system of claim 11, wherein the digital computational learning system is a neural network.

13. The system of claim 12, wherein the neural network is a feed-forward neural network, convolutional neural network, recurrent neural network, or long short-term memory neural network.

14. The system of claim 12, wherein the neural network includes a back propagation stage, the back propagation stage including the compute, convert, adjust, and update operations.

15. The system of claim 12, wherein the adjustable parameters are connection weights between neurons and biases of neurons of the neural network and wherein to adjust the adjustable parameters, the sequence of instructions further causes the at least one processor to apply multiplying factors of value greater than one, the multiplying factors including a weight multiplying factor or a bias multiplying factor, and apply the weight multiplying factor to a connection weight parameter and the bias multiplying factor to a bias parameter.

16. The system of claim 15, wherein to train the digital computational learning system, the sequence of instructions further causes the at least one processor to compute the multiplying factors and a first and second back propagation scaling factor based on a first, second, and third forward propagation scaling factor, wherein to compute the multiplying factors and the first and second back propagation scaling factors, the sequence of instructions further causes the at least one processor to:
set a maximum scaling factor value based on a numerical overflow constraint;
compute the first back propagation scaling factor based on a first ratio of the maximum scaling factor value to the second forward propagation scaling factor;
compute the second back propagation scaling factor based on a first product of the second forward propagation scaling factor and the first back propagation scaling factor computed;
compute the weight multiplying factor based on a second ratio of a second product of the third forward propagation scaling factor and the first back propagation scaling factor computed to the second forward propagation factor; and
compute the bias multiplying factor based on a third ratio of the second back propagation scaling factor computed to the first forward propagation scaling factor, wherein the first, second, and third forward propagation scaling factors and the first and second back propagation scaling factors enable conversion of values of the one or more finer granularities to the coarser granularity.

17. The system of claim 15, wherein to train the digital computational learning system, the sequence of instructions further causes the at least one processor to:
set the bias multiplying factor based on at least two constraints, the at least two constraints including (a) constraining the bias multiplying factor to a value greater than one and (b) constraining a first ratio to an integer, the first ratio computed based on the bias multiplying factor and a first, second, and third forward propagation scaling factor, the first ratio relating a first product to the second forward propagation scaling factor squared, the first product produced by multiplying the bias multiplying factor with the first and third forward propagation scaling factors;
compute the weight multiplying factor by computing the first ratio;
compute a first and second back propagation scaling factor, wherein the second back propagation scaling factor is computed based on a second product of the bias multiplying factor and the first forward propagation factor and wherein the first back propagation scaling factor is based on a second ratio of the second back propagation scaling factor computed to the second forward propagation scaling factor; and
wherein the first, second, and third forward propagation scaling factors and the first and second back propagation scaling factors enable conversion of values of the one or more finer granularities to the coarser granularity.

18. The system of claim 11, wherein the given input is a digital representation of a voice, image, or signal and the sequence of instructions further causes the at least one processor to employ the digital computational learning system in a speech recognition, image recognition, motion control, or communication application.

19. The system of claim 11, wherein the digital computational learning system is employed in a credit card, fraud detection, tax return, income level, foreign account, bank account, tax level, or health care application, or other application that distinguishes between sets of things.

20. A non-transitory computer-readable medium for training a neural network, the non-transitory computer-readable medium having encoded thereon a sequence of instructions which, when loaded and executed by at least one processor, causes the at least one processor to:
compute a sum of a present error term and an accumulated error term, the present error term being a function of an expected voice related output and an actual voice related output of the neural network to a given voice related input in a present iteration of the training, the accumulated error term accumulated over previous iterations of the training, the present error term, accumulated error term, and the sum having a finer granularity relative to a coarser granularity of adjustable parameters within the neural network;
convert the sum to a converted sum having the coarser granularity;
adjust the adjustable parameters as a function of the converted sum in the present iteration;
update the accumulated error term, having the finer granularity, for use in adjusting the adjustable parameters, having the coarser granularity, in a next iteration of the training of the neural network, the update operation including applying a difference between the converted sum and the sum, the difference having the finer granularity; and
wherein the neural network includes a back propagation stage, the back propagation stage including the compute, convert, adjust, and update operations, and
wherein the compute, convert, adjust, and update operations improve a computational speed and reduce a memory usage of the neural network while maintaining an accuracy of the training relative to a different method of training the neural network, the different method based exclusively on one or more finer granularities finer than the coarser granularity.
